(19) United States
(12) Patent Application Publication
(10) Pub. No.: US 2026/0045562 A1
(43) Pub. Date: Feb. 12, 2026

(54) Assembly for an Electrical Energy Storage Device With Heat-Conducting Sheet

(71) Applicant: Bayerische Motoren Werke Aktiengesellschaft, Muenchen (DE)

(72) Inventors: Franz BONAUER, Unterschleissheim (DE); Nicolas FLAHAUT, Muenchen (DE); Matthias REIL, Muenchen (DE); Philipp SCHLAG, Groebenzell (DE); Martin SPAETH, Muenchen (DE)

(21) Appl. No.: 19/100,675

(22) PCT Filed: Sep. 27, 2023
(86) PCT No.: PCT/EP2023/076728

§ 371 Date: Feb. 3, 2025

(30) Foreign Application Priority Data
Oct. 18, 2022 (DE) 10 2022 127 273.7

(51) Int. Cl. H01M 10/42; H01M 10/625; H01M 10/655; H01M 50/224; H01M 50/249

(52) U.S. Cl. CPC H01M 10/425; H01M 10/625; H01M 10/655; H01M 50/224; H01M 50/249; H01M 2010/4271

(57) ABSTRACT

An assembly for an electrical energy storage device of a motor vehicle includes: a holding frame which can be fastened in a storage housing of the electrical energy storage device for receiving a storage module of the electrical energy store and arranging the storage module at an elevated level with respect to a storage housing wall; a cell monitoring device for monitoring a state of storage cells of the storage modules and initiating a charge state compensation of the storage cells, with a plastic housing and cell monitoring electronics arranged in the plastic housing; and a heat-conducting plate arranged between the holding frame and the plastic housing for transferring waste heat of the cell monitoring device to the holding frame. The heat-conducting plate is arranged to rest flat against the plastic housing and is fastened, together with the plastic housing, to the projections for thermal coupling with the holding frame.

### BACKGROUND AND SUMMARY

The invention relates to an assembly for an electrical energy storage device of a motor vehicle. The invention additionally relates to an electrical energy device and to a motor vehicle.

Interest in this case is focused on electric energy storage devices that may be used, for example, as traction batteries for electrically powered motor vehicles, such as, for example, hybrid or electric vehicles. Such electrical energy storage devices may have a multiplicity of storage modules having interconnected storage cells that are arranged in a storage housing of the electrical energy storage device. To monitor the storage cells, it is common practice to equip the storage cells at least partially with monitoring sensors and monitoring actuators that can communicate with cell monitoring electronics of a cell monitoring device or CSC (cell supervision circuit) arranged in the storage housing. For example, the monitoring sensors may have voltage sensors for sensing the respective cell voltages. For example, the monitoring electronics may use asymmetrical cell voltages to recognize mutually differing charge states of the storage cells and drive the monitoring actuators to perform a charge-state equalization, a so-called cell balancing, thereby achieving voltage symmetrization of the storage cells.

The symmetrization of the storage cells results in an increase in the temperature of the cell monitoring device, which may result in overheating and thus turn off the cell monitoring electronics. It is therefore necessary to remove the waste heat from the cell monitoring device and thereby cool the cell monitoring device.

An object of the present disclosure is to provide a simple, cost-effective and space-saving option for heat dissipation for a cell monitoring device of an electrical energy storage device of a motor vehicle.

This object may be achieved according to the invention by an assembly, an electrical energy storage device and by a motor vehicle having the features according to the respective independent patent claims. Advantageous embodiments of the invention are provided by the dependent claims, the description and the figures.

An assembly according to the disclosure for an electrical energy storage device of a motor vehicle has a holding frame, that can be fastened in a storage housing of the electrical energy storage device, for receiving at least one storage module of the electrical energy storage device and for arranging the at least one storage module in an elevated position with respect to a storage-housing wall of the storage housing. In addition, the assembly has a cell monitoring device, arranged on the holding frame, for monitoring a state of storage cells of the storage modules and for initiating a charge-state equalization of the storage cells. The cell monitoring device has a plastic housing, and cell monitoring electronics that are arranged in the plastic housing. An outer side of at least one frame element of the holding frame has projections, for fastening and supporting the plastic housing, via which the cell monitoring device is mechanically connected to the holding frame. The assembly also comprises a heat-conducting plate, arranged between the holding frame and the plastic housing, for removing waste heat from the cell monitoring device to the holding frame. The heat-conducting plate is arranged so that it bears flatly against the plastic housing and, for thermal coupling to the holding frame, is fastened and supported, together with the cell monitoring device, on the projections.

The invention also includes an electrical energy storage device for a motor vehicle. The electrical energy storage device has a storage housing, a multiplicity of storage modules arranged in the storage housing, and an assembly according to the disclosure. At least one storage module of the electrical energy storage device is arranged in the holding frame and held in an elevated position with respect to a storage-housing base of the storage housing, forming a cavity for receiving at least one storage component of the electrical energy store. The electrical energy storage device is, in particular, a high-voltage energy storage device and serves as a rechargeable traction battery, or traction accumulator, or the motor vehicle. The storage modules, or battery modules, have, in particular, cell stacks of prismatic storage cells, or battery cells, that are stacked together and interconnected. The storage housing of the electrical energy storage device may be realized, for example, in two parts and comprise a dish-shaped storage-housing lower part and a dish-shaped storage-housing upper part. The storage-housing lower part comprises a storage-housing wall in the form of a storage-housing base, and the storage-housing upper part comprises a storage-housing wall in the form of a storage-housing cover. When assembled, the side parts of the housing lower part and the housing upper part form a storage-housing wall in the form of a wraparound side wall.

There may be a plurality of holding struts, for fastening and holding the storage modules, arranged on the storage-housing base. These storage modules fastened to the holding struts are arranged in a first plane. At least one storage module is fastened to the holding frame of the assembly, which arranges the at least one storage module in an elevated position with respect to the other storage modules and in an elevated position with respect to the storage-housing base. This storage module arranged in the holding frame is arranged in a second plane. The holding frame is fastened, for example, to the storage-housing lower part and arranged in an end sub-region of the storage housing, which, when the energy storage device is installed in the motor vehicle, is located beneath a rear seat bench of the motor vehicle. The holding frame is, in particular, an aluminum cast component. The holding frame is realized, for example, in a rectangular shape having two long-side frame elements and two short-side frame elements. When the energy storage device is installed in the motor vehicle, the long-side frame elements extend, for example, along a transverse direction of the vehicle, and the short-side frame elements extend along a longitudinal direction of the vehicle. To hold the elevated storage module, it is for example hooked into the holding frame, with the short-side frame elements extending along opposite end faces of the cell stack, and the long-side frame elements extending along side regions of the storage cells that are stacked together. As a result of the at least one storage module being arranged in an elevated manner with respect to the storage-housing base, a cavity is formed between the storage-housing base and an underside of the storage module, in which further storage components, for example storage electronics, may be arranged.

The electrical energy storage device also comprises the cell monitoring device, which can communicate with monitoring sensors and monitoring actuators of the storage modules. The cell monitoring device comprises the cell monitoring electronics, which may comprise, for example, printed circuit boards having integrated circuits. These cell monitoring sensors are arranged in the plastic housing and connected to the monitoring sensors and monitoring actuators. For example, plug-in connectors of the cell monitoring electronics, which are contacted to plug-in connectors of lines connected to the monitoring sensors and the monitoring actuators, may be routed out of the plastic housing. The cell monitoring device is designed to receive sensor data from the monitoring sensors, for example cell voltages or module voltages, and to drive the monitoring actuators, for example balancing circuits of the storage cells and/or of the storage modules, based on the sensor data in order to symmetrize the cell voltages or module voltages.

The cell monitoring device in this case is also fastened to the holding frame. In particular, the cell monitoring device is arranged on one of the long-side frame elements. For this purpose, the holding frame has projections, which are formed integrally with one of the frame elements and which are realized, for example, as screw bosses. The plastic housing is supported by these projections and connected to the holding frame, for example screw-connected. The plastic housing is realized, in particular, as a flat housing, wherein a height of the flat housing corresponds at most to a height of the frame element, and a length of the flat housing is less than a length of the frame element. A thickness of the flat housing is significantly less than the height and width of the flat housing. As a result of the plastic housing being arranged on the projections, the plastic housing does not bear flatly against the holding frame, but is arranged at a distance from the holding frame, forming an interspace, such that, owing to the poor thermal conductivity of the plastic housing, there cannot be any sufficient transfer of heat between the cell monitoring device and the holding frame. If the cell monitoring electronics heat up upon symmetrization of the voltages, this can consequently result in overheating, and in failure of the cell monitoring electronics.

The heat-conducting plate, or heat transfer plate, is provided to improve heat transfer between the cell monitoring device and the holding frame. The heat-conducting plate may be, for example, an aluminum plate. The heat-conducting plate is placed against the wall of the plastic housing that faces toward the outer side of the frame element to which the cell monitoring device is fastened. The heat-conducting plate is thus arranged between the plastic housing and the holding frame. In particular in this case, geometric dimensions of the heat-conducting plate correspond at least to geometric dimensions of the wall of the plastic housing, such that the wall of the plastic housing is completely covered by the heat-conducting plate.

The heat-conducting plate is thermally coupled to the holding frame in that it bears against the projections of the holding frame and is also fastened there. For example, the heat-conducting plate may have, in the region of the screw bosses, through-holes arranged in alignment with through-openings in the plastic housing. The through-holes and through-openings form screw holes, through which screws can be passed for fastening the heat-conducting plate and the plastic housing to the holding frame. Since the heat-conducting plate bears flatly against the plastic housing, a good transfer of heat can be provided between the cell monitoring electronics and the heat-conducting plate. The heat-conducting plate, which has a greater thermal conductivity than the plastic housing, can remove the heat via the projections to the holding frame.

Such a cooling system for the cell monitoring electronics, provided by a heat-conducting plate, may be realized in a particularly simple and cost-effective manner, for example as a stamped and bent part, and is particularly lightweight and requires little installation space. Moreover, it may be integrated into the electrical energy storage device without any other redesign measures.

It proves to be advantageous if the heat-conducting plate has embossings to compensate for unevenness when the heat-conducting plate has been applied to the plastic housing. The embossings of the heat-conducting plate may in particular be arranged to overlap with regions of the monitoring electronics arranged in the plastic housing that are at risk of overheating. It is desirable to arrange the heat-conducting plate so that it bears with full surface contact against the plastic housing. However, due to production-related and material-related unevenness of the heat-conducting plate, this is difficult to achieve. The embossings are therefore provided to compensate for this unevenness and thereby increase the surface area of the heat-conducting plate available for the conduction of heat.

It may also be provided that the heat-conducting plate has positioning and holding elements for the plastic housing that are in the form of bending tabs. The positioning and holding elements in the form of bending tabs may be arranged in particular at the edges of the heat-conducting plate and form an enclosure for the plastic housing. In this way, the plastic housing may be fitted with the heat-conducting plate, and the unit composed of the heat-conducting plate and the plastic housing may be fastened to the projections of the holding frame, forming the assembly.

The invention also includes a motor vehicle comprising at least one electrical energy storage device according to the invention. The electrical energy storage device may form, in particular, a traction battery of the motor vehicle, such that the motor vehicle is realized as an electrified motor vehicle.

The embodiments presented with reference to the assembly according to the disclosure and their advantages apply accordingly to the electrical energy storage device according to the disclosure and to the motor vehicle according to the disclosure.

Further features of the invention are given by the claims, the figures and the description of the figures. The features and combinations of features mentioned above in the description, as well as the features and combinations of features mentioned below in the description of the figures and/or shown alone in the figures, can be used not only in the combination indicated in each case, but also in other combinations or on their own.

The invention will now be explained in more detail with reference to a preferred exemplary embodiment and with reference to the drawings.

### BRIEF DESCRIPTION OF THE DRAWINGS

FIG. 1 shows a perspective representation of a storage-housing part and of an assembly of an electrical energy storage device;

FIG. 2 shows an exploded representation of the assembly;

FIG. 3 shows a perspective representation of a holding frame and of a heat-conducting plate of the assembly;

FIG. 4 shows a perspective representation of the heat-conducting plate of the assembly.

In the figures, elements that are the same, and elements that have the same function, are denoted by the same reference designations.

### DETAILED DESCRIPTION OF THE DRAWINGS

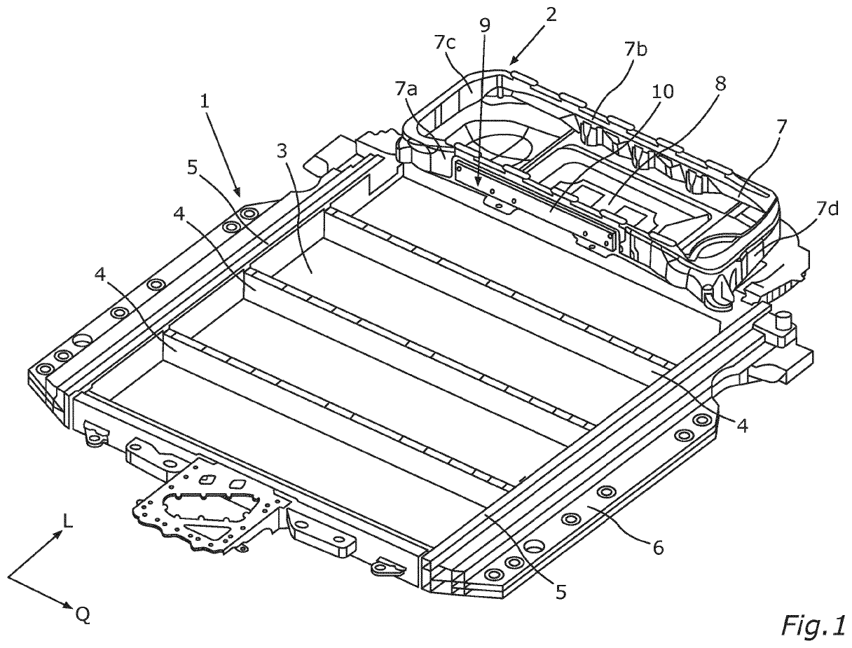

FIG. 1 shows a perspective representation of a storage-housing part 1 and of an assembly 2 of an electrical energy storage device for a motor vehicle. The storage-housing part 1 here is a dish-shaped storage-housing lower part and has a storage-housing wall 3 in the form of a storage-housing base. Arranged on the storage-housing base 3, for example by welding, there are holding struts 4, to which storage modules of the electrical energy store, not shown here, may be fastened. The holding struts 4 in this case extend between two side parts 5 of the storage housing part 1 that lie opposite each other in the transverse direction Q of the vehicle when the energy storage device is in its proper installed position in the motor vehicle. The storage modules may be made up of prismatic storage cells that are stacked together along a stacking direction. The stacking direction in this case corresponds to the direction in which the retaining struts 4 extend along the transverse direction Q of the vehicle. Fastening regions 6 extending laterally on the side parts 5 in the longitudinal direction L of the vehicle serve to fasten the electrical energy storage device to a body of the motor vehicle.

The assembly 2 has a holding frame 7, which is arranged in an end sub-region 8 of the storage housing part 1 and fastened to the storage housing part 1. The rectangular holding frame 7 has a plurality of frame elements 7a, 7b, 7c, 7d. Two frame elements 7a, 7b in this case are realized as long-side frame elements extending in the transverse direction Q of the vehicle, and two frame elements 7c, 7d are realized as short-side frame elements extending in the longitudinal direction L of the vehicle. At least one storage module may be fastened to the holding frame 7, such that this storage module is arranged in an elevated position with respect to the storage-housing base 3. This forms a cavity 8 in the storage housing beneath the raised storage module, in which further storage components, for example storage electronics, may be arranged.

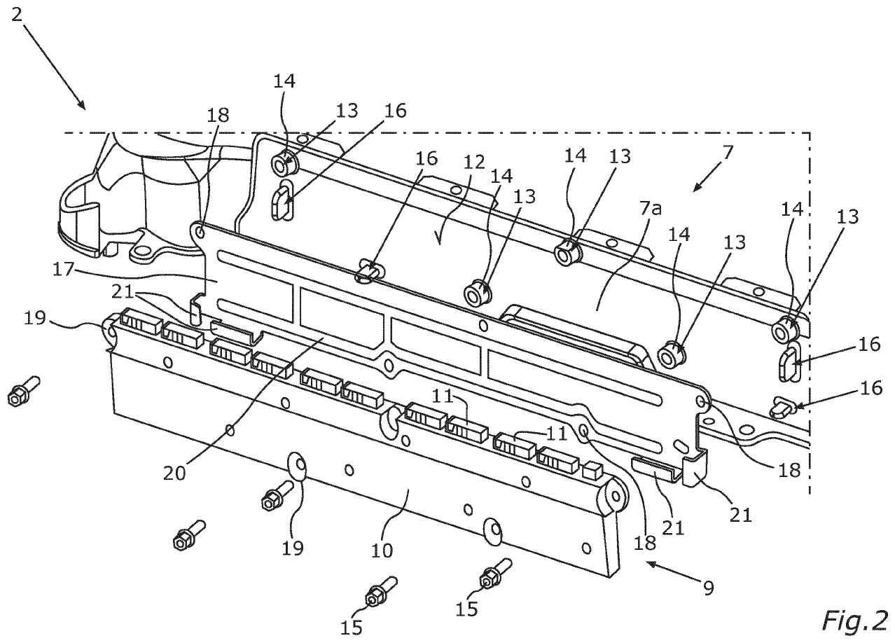

Also arranged on the holding frame 7 is cell monitoring device 9 that serves to monitor the storage cells of the storage modules. As shown in the exploded representation of the assembly 2 in FIG. 2, the cell monitoring device 9 has a flat, cassette-type plastic housing 10 in which cell monitoring electronics, which are not visible here, are arranged. Plug-in connectors 11, for electrically connecting the cell monitoring electronics to monitoring sensors and actuators of the storage modules, protrude from the plastic housing 10. The cell monitoring device 9 is fastened here to the frame element 7a of the holding frame 7 that faces toward the interior of the storage housing, and thus toward the rest of the storage modules. For this purpose, an outer side 12 of this frame element 7a has projections 13 for fastening and supporting the plastic housing 10. The projections 13 are realized, for example, as screw bosses 14 that serve to fasten the plastic housing 10 by way of screws 15. In addition, the outer side 12 has wall-type delimiting elements 16 that delimit the installation region of the plastic housing 10 on the outer side 12 of the frame element 7a. The plastic housing 10 may be placed against or on these delimiting elements 16 for the purpose of positioning and holding.

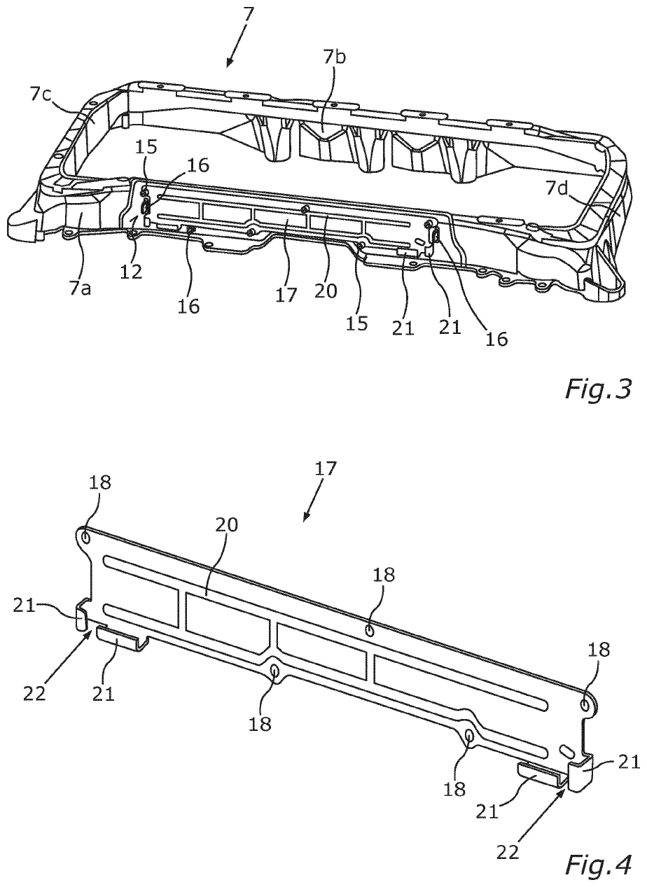

Due to the low thermal conductivity of the plastic housing 10 and the small surface area of thermal interfacing of the plastic housing 10 to the holding frame 7 via the screw bosses 14, waste heat from the cell monitoring electronics may only be insufficiently removed to the holding frame 7, which may be realized in particular as an aluminum casting. For this reason, the assembly 2 additionally has a heat-conducting plate 17, which is arranged in an intermediate plane between the holding frame 7 and the plastic housing 10. The heat-conducting plate 17 is arranged so as to bear against the plastic housing 10, such that it completely covers one wall of the plastic housing 10. The heat-conducting plate 17 has through-holes 18 that are arranged in alignment with through-openings 19 of the plastic housing 10 and with the screw bosses 14. Thus, the screws 15 can be inserted into the screw bosses 14 through the through-openings 19 and the through-holes 18, thereby fastening the heat-conducting plate 17 and the cell monitoring device 9 to the holding frame 7. The heat-conducting plate 17 is thermally coupled to the holding frame 7 via the screw bosses 14. FIG. 3 shows the holding frame 7 with the heat-conducting plate 7 fastened to it, without the cell monitoring device 9. FIG. 4 shows only the heat-conducting plate 17.

The heat-conducting plate 17 also has embossings 20, which are arranged in the region of the heat-conducting plate 17 that overlaps with regions of the cell monitoring electronics that are at risk of overheating. The embossings 20 serve to compensate for unevenness of the heat-conducting plate 17, such that it bears as fully as possible against the plastic housing 10. In addition, the heat-conducting plate 17 has hook-shaped, bending-tab-type positioning and holding elements 21, which serve to hold the plastic housing 10. The positioning and holding elements 21 are arranged here in the region of opposite lower corners 22 of the heat-conducting plate 17 in the transverse direction Q of the vehicle, such that the plastic housing 10 may be enclosed by the positioning and holding elements 21 and held on the heat-conducting plate 17.

1-10. (canceled)

11. An assembly for an electrical energy storage device of a motor vehicle, the assembly having:
a holding frame configured to be fastened in a storage housing of the electrical energy storage device for receiving at least one storage module of the electrical energy storage device and for arranging the at least one storage module in an elevated position with respect to a storage-housing wall of the storage housing;
a cell monitoring device arranged on the holding frame for monitoring a state of storage cells of the storage modules and for initiating a charge-state equalization of the storage cells, the cell monitoring device comprising:
a plastic housing, and
cell monitoring electronics arranged in the plastic housing, wherein an outer side of a frame element of the holding frame has projections for fastening and supporting the plastic housing, whereby the cell monitoring device is fastened to the holding frame; and
a heat-conducting plate arranged between the holding frame and the plastic housing for removing waste heat from the cell monitoring device to the holding frame, wherein the heat conducting plate is arranged so that it bears flatly against the plastic housing and, for thermal coupling to the holding frame, is fastened and supported together with the plastic housing on the projections.

12. The assembly according to claim 11, wherein
the projections are realized on the outer side of the frame element as screw bosses through which the plastic housing and the heat-conducting plate are screw-connected to the holding frame.

13. The assembly according to claim 11, wherein
the heat-conducting plate has embossings to compensate for unevenness when the heat-conducting plate is applied to the plastic housing.

14. The assembly according to claim 13, wherein
the embossings of the heat-conducting plate are arranged to overlap with regions of the monitoring electronics arranged in the plastic housing that are at risk of overheating.

15. The assembly according to claim 11, wherein
the heat-conducting plate has positioning and holding elements for the plastic housing, the positioning and holding elements having a form of bending tabs.

16. The assembly according to claim 11, wherein
the plastic housing is realized as a flat housing,
a height of the flat housing corresponds at most to a height of the frame element, and
a length of the flat housing is less than a length of the frame element.

17. The assembly according to claim 11, wherein
the holding frame is realized in a rectangular shape and has more than one frame element including two long-side frame elements and two short-side frame elements, and
the cell monitoring device is arranged on one of the long-side frame elements.

18. The assembly according to claim 11, wherein
the holding frame is an aluminum cast part.

19. An electrical energy storage device for a motor vehicle, the electrical energy storage device having:
a storage housing,
a multiplicity of storage modules that are arranged in the storage housing,
an assembly according to claim 11, wherein
at least one storage module is arranged in the holding frame in an elevated position with respect to the storage-housing base of the storage housing, forming a cavity for receiving at least one storage component of the electrical energy storage device.

20. A motor vehicle comprising at least one electrical energy storage device according to claim 19.
